(19) United States
(12) Patent Application Publication
(10) Pub. No.: US 2014/0253718 A1
(43) Pub. Date: Sep. 11, 2014

(54) METHOD AND APPARATUS FOR NECKING AND FLANGING A METALLIC BOTTLE

(71) Applicant: REXAM BEVERAGE CAN COMPANY, Chicago, IL (US)

(72) Inventors: Doug Leitzen, Marengo, IL (US); Andrea Bevill, Hanover Park, IL (US); Robert P. Perez, Gurnee, IL (US)

(73) Assignee: REXAM BEVERAGE CAN COMPANY, Chicago, IL (US)

(21) Appl. No.: 13/793,270

(22) Filed: Mar. 11, 2013

(51) Int. Cl. G01N 21/95; B21D 51/26

(52) U.S. Cl. CPC G01N 21/9515; B21D 51/2638; B21D 51/263
USPC 348/92; 72/31.01; 348/86

(57) ABSTRACT

An apparatus for continuously reforming an open end of a metallic can body has a plurality of sequentially aligned necking stations and a flanging station. An inspection station is sequentially aligned with the flanging station and has a camera for capturing a plurality of images about a circumference of the metallic beverage container as the metallic beverage container completes one full rotation about a generally vertical axis during a dwell period. A plurality of transfer wheels are sequentially aligned with the plurality of necking stations, the flanging station, and the inspection station. The transfer wheels sequentially transfer the metallic container between each of the plurality of necking stations, the flanging station, and the inspection station.

### CROSS-REFERENCE TO RELATED APPLICATIONS

N/A

### FEDERALLY SPONSORED RESEARCH OR DEVELOPMENT

N/A

### TECHNICAL FIELD

The invention relates to necking and flanging aluminum bottles; more particularly, the present invention relates to a necking and flanging apparatus having an in-line, continuous, inspection module capable of full-body inspection incorporated therein.

### BACKGROUND OF THE INVENTION

Referring to FIG. 1, bottles 10 produced from metallic materials are becoming more and more popular in the beverage market. These bottles 10 are typically produced from an aluminum alloy because aluminum alloys tend to form well and are capable of maintaining adequate strength even drawn and ironed down to a very thin thickness. A lower portion 12 or body of the metallic bottle includes an enclosed bottom 16 and a cylindrical sidewall 18 extending upwardly from the enclosed bottom portion 16.

The bottom 16 has a dome-shaped center panel surround by a generally a circumferential annular support 20. An outer wall 22 extends radially outwardly and upwardly relative to the annular support 20 and joins the bottom 16 with the lowermost portion of the cylindrical sidewall 18.

The cylindrical sidewall 18 is centered about the longitudinal axis. The sidewall 18 is generally smooth and flat; however, any one of a number of forming techniques can be employed to impart a shape and/or texture to the sidewall 18. For instance, the interior of the sidewall 18 could be forced outwardly by a fluid pressure or forming segments, laser treatment could be employed to etch or otherwise mark the sidewall 18, and/or flutes or other designs may be imparted onto the sidewall 18 through mechanical deformation of the sidewall 18.

An upper portion 14 of the bottle 10 includes a circumferential shoulder portion 26. The shoulder 26 has a convexly curved appearance when viewed from a vantage point external to the container 10. The shoulder 26 has a lowermost point integral with an uppermost portion of the cylindrical sidewall 18. The transition point between the sidewall 18 and shoulder 26 is at a point where the can body 10 begins to curve radially inwardly. Stated another way, the diameter of the container body 10 begins to decrease at the point where the shoulder 26 begins and the sidewall 26 ends.

It is believed that the radius of curvature of the shoulder 26 is important for the aesthetic appearance of the container 10 as well as for the strength of the container 10.

The shoulder 26 has a smoothly tapered appearance. This appearance is achieved through a die forming technique similar to the die forming technique disclosed in commonly assigned U.S. Pat. No. 5,497,900 which is hereby incorporated by reference as if fully set forth herein. The smoothly tapered appearance differs from containers produced using alternative methods like spin-necking in that the radius of curvature is much greater so that wrinkles and scratches are avoided as is the unsightliness of an abrupt reduction in the diameter of the container caused by a sharp corner or bend at the shoulder. Thus, a vertical length of the shoulder 26, parallel to the longitudinal axis, is greater than the vertical length of shoulders produced through other forming techniques.

The upper portion 14 further includes an inwardly tapered circumferential neck 28. The neck 28 has a lowermost portion integral with an uppermost portion of the shoulder 26. Thus, the neck 28 functions to further decrease the diameter of the container 10 along the vertical length of the neck 28. The neck 28 is typically substantially flat, i.e. primarily free of an arc-shape design, although it may have some discontinuity formed during production. It is entirely possible that future generations of such containers may have curved necks 28 and curved sidewalls 18, and the present invention is particularly useful in producing and inspecting same as will be described in detail below.

The upper portion terminates at a flange 30 which is adapted for receiving a cap or closure member.

U.S. Pat. No. 5,497,900 describes a die necking method for necking can bodies. The method of the '900 patent contemplates forming a cylindrical neck portion adjacent the cylindrical open end of a container so that the cylindrical neck merged with the cylindrical side wall through a generally smoothly tapered neck portion. The tapered neck portion between the cylindrical neck portion and the cylindrical container side wall initially is defined by a lower, generally arcuate segment having a relatively large internal curvature at the upper end of the cylindrical side wall and an upper, generally arcuate segment having a relatively large external curvature at the lower end of the reduced cylindrical neck. A further tapered portion is then formed at the open end and is forced downwardly while the cylindrical neck is further reduced. The further tapered portion freely integrates with the second arcuate segment which is reformed and the tapered portion is extended. This process is repeated sequentially until the cylindrical neck is reduced to the desired diameter and a smoothly tapered necked-in portion is formed on the end of the side wall. In each necking operation, the tapered portion is not constrained by the die and is freely formed without regard to the specific dimensions of the die transition zone.

The container that is formed by the above die necking process has an aesthetically-pleasing appearance, greater strength and crush resistance and is devoid of the scratches or wrinkles in the neck produced in a spin necking operation. Similar methods are still used today.

Even with an increased number of necking operations, small wrinkles may form on or near the open edge of the can. These wrinkles may be ironed out during subsequent necking operations by forcing the edge of the can between the cylindrical upper portion of the necking die and the floating pilot member. The ironed out wrinkles create localized regions exhibiting increased work hardening that are generally more brittle than adjacent areas and may fail (i.e. fracture or crack) when the open end is flanged.

Wrinkles become even more prevalent as the container sidewall is down-gauged. To avoid wrinkling, four to six additional necking operations may be required. Additional necking operations, however, require additional manufacturing space, pressurized air, electricity, and manufacturing time. Thus, adding additional necking operations is cost prohibitive.

Currently, aluminum bottles 10 are inspected individually by hand. That is, a prescribed number of aluminum bottles are removed from pallets, inspected by manufacturing plant personnel for wrinkles, cracks, dents, pleats, and/or fractures, and palletized again or repalletized. The prescribed number is up to 100% of the manufactured aluminum bottles. It is important for the inspection to take place over the entire circumference of the bottle and the entire height or a portion of the entire height of the container to ensure compliance with quality standards, which can include container decoration and/or ink printing which takes place prior to necking and flanging. This process is time consuming, labor intensive, and subject to human error. Moreover, due to the speed of manufacturing and the frequency of inspection or sampling, such manual inspection is a manufacturing bottleneck unless a large population of human inspectors is employed. In beverage production manufacturing defects are typically measured in defective parts per million, making it difficult to cull or locate defective beverage can bodies by hand. Therefore, human inspection is inefficient, ineffective, costly, and subject to mistakes.

There are no known automated inspection apparatuses that can efficiently and accurately inspect a full 360° of an aluminum bottle in a timely and cost efficient manner.

The present invention is provided to solve the problems discussed above and other problems, and to provide advantages and aspects not provided by prior necking and flanging apparatuses of this type. A full discussion of the features and advantages of the present invention is deferred to the following detailed description, which proceeds with reference to the accompanying drawings.

### SUMMARY OF THE INVENTION

One aspect of the present invention is directed to an apparatus for continuously reforming an open end of a metallic can body as described above. The apparatus comprises a plurality of sequentially aligned necking stations, a flanging station, an inspection station, and a plurality of transfer wheels. The plurality of sequentially aligned necking stations each reduce a diameter of an open end of a metallic beverage container body wherein a subsequent necking station reduces the diameter of the open end of the metallic beverage container a degree or amount beyond a reduction in the diameter taken at a previous necking station. The flanging station is sequentially aligned with a last of the plurality necking stations wherein the open end of the metallic beverage container is further reformed by the flanging station. The inspection station is sequentially aligned with the flanging station and comprises an image recorder for capturing a plurality of images about a circumference of the metallic beverage container as the metallic beverage container completes one full rotation about a generally vertical axis during a dwell period. The plurality of transfer wheels are sequentially aligned with the plurality of necking stations, the flanging station, and the inspection station. The transfer wheels sequentially transfer the metallic beverage container between each of the plurality of necking stations, the flanging station, and the inspection station.

The first aspect of the invention may include one or more of the following features, alone or in any reasonable combination. The apparatus may further comprise a computer system having a memory in communication with the image recorder and receiving images of the beverage container from the image recorder. The apparatus may further comprise a first software routine stored in the memory for stitching the plurality of images together to form a composite of a circumference of each metallic beverage container. The apparatus may further comprise a second software routine stored in the memory for identifying manufacturing defects on the composite. The inspection station may have an ejector positioned along an indexed path and activated by a software routine stored in the memory of the computer system wherein activation of the ejector removes an individual beverage container from the inspection station when the a software routine identifies a manufacturing defect on the individual beverage container. The ejector may receive a fluid pressure from a source of fluid pressure in response to a signal originating from the computer system. The ejector may be a blow-off nozzle.

Another aspect of the present invention is directed to an apparatus for continuously reforming an open end of a metallic can body as described above. The apparatus comprises a circumferential first indexer and an image recorder. The first indexer sequentially transports a plurality of metallic beverage containers from a first location to a second location along an indexed path which has a plurality of dwell positions. Each of the plurality of metallic containers pauses at a dwell position for a predetermined time interval as each of the plurality of metallic beverage containers is sequenced from the first location to the second location. The first indexer comprises a plurality of turntables. Each turntable supports an enclosed bottom portion of the metallic beverage container and is rotational about a generally vertical axis for transferring rotation to the metallic beverage container. Each turntable is transferred by the first indexer along the indexed path from the first location to the second location. The image recorder is aimed at the one of the dwell positions for capturing a plurality of images about a circumference of each of the plurality of metallic beverage containers as each of the plurality of metallic beverage containers completes at least one full rotation about the generally vertical axis during the predetermined time interval.

The second aspect of the invention may include one or more of the following features, alone or in any reasonable combination. The apparatus may further comprise a computer system having a memory wherein the computer system is in communication with the image recorder and receives images of the beverage container from the image recorder. The apparatus may further comprise a software routine for stitching the plurality of images together to form a composite of a circumference of each metallic beverage container. The apparatus may further comprise a software routine for identifying manufacturing defects on the composite. The apparatus may further comprise an ejector positioned along the indexed path and activated by a software routine stored in the memory of the computer system wherein activation of the ejector removes an individual beverage container from the inspection station when a software routine identifies a manufacturing defect on the individual beverage container. The ejector may receive a fluid pressure from a source of fluid pressure in response to a signal originating from the computer system. The ejector may be a blow-off nozzle.

Another aspect of the invention is directed to an apparatus for inspecting a metallic beverage container having a closed bottom opposite an open end, and a cylindrical sidewall extending upwardly from the bottom to a circumferential shoulder. The apparatus comprises a rotatable indexer, an image recorder and a computer system. The rotatable indexer sequentially transports a plurality of metallic beverage containers from a first location to a second location along an indexed path having a plurality of dwell positions wherein each of the plurality of metallic containers pauses at a dwell position for a predetermined time interval as each of the plurality of metallic beverage containers is sequenced from the first location to the second location. The rotatable indexer comprises a plurality of turntables. Each turntable supports an enclosed bottom portion of the metallic beverage container and is rotational about a generally vertical axis which transfers rotation to the metallic beverage container. Each turntable is further transferred by the rotatable indexer along the indexed path from the first location to the second location. The image recorder is aimed at one of the dwell positions and captures a plurality of images about a circumference of each of the plurality of metallic a beverage containers as each of the plurality of metallic beverage containers completes at least one full rotation about the generally vertical axis on one of the plurality of turntables during the predetermined time interval. The computer system is in communication with the image recorder and comprises a software routine for stitching together the plurality of images to form a composite image representing the circumference of each of the metallic beverage containers. An ejector is positioned along the indexed path and activated by signal originating from the computer system wherein activation of the ejector removes the metallic beverage container from the inspection station when a manufacturing defect is identified on the metallic beverage container beverage container. The ejector may receive a fluid pressure from a source of fluid pressure in response to a signal originating from the computer system. The ejector may be a blow-off nozzle.

Another aspect of the present invention is directed to a method of inspecting a metallic beverage container having a closed bottom opposite an open end, a cylindrical sidewall extending upwardly from the bottom to a circumferential shoulder, and a neck of reducing diameter extending upwardly from the shoulder. The method comprises the steps of: (1) sequentially transporting a plurality of metallic beverage containers from a first location to a second location along an indexed path having a plurality of dwell positions therebetween; (2) pausing transport of each of the plurality of metallic beverage containers at one of the dwell positions for a predetermined time interval; (3) recording a plurality of images of a height from an open end to an opposing closed end of each of the plurality of metallic beverage containers about a full circumference of each of the plurality of the metallic beverage containers; and (4) creating a composite image corresponding to the height and the circumference of each of the plurality of metallic beverage containers from the plurality of images.

This aspect of the invention may include one or more of the following features, alone or in any reasonable combination. The method may further comprise the step of using a software routine to identify manufacturing defects on the composite image. The method may further comprise the step of rotating each of the plurality of metallic beverage containers about a generally vertical axis defined by a center of each of the plurality of metallic beverage containers during the recording step. The method may further include the step of automatically culling a defective beverage container from a plurality of sequentially processed beverage containers. The invention may include an ejector positioned along the indexed path and activated by a software routine stored in the memory of the computer system. Activation of the ejector removes an individual beverage container from the inspection station when the second software routine identifies a manufacturing defect on the individual beverage container. The ejector may receive a fluid pressure from a source of fluid pressure in response to a signal originating from the computer system. The ejector may be a blow-off nozzle.

Another aspect of the present invention is directed to a method of inspecting a metallic beverage container having a closed bottom opposite an open end, a cylindrical sidewall extending upwardly from the bottom to a circumferential shoulder, and a neck of reducing diameter extending upwardly from the shoulder, The method comprises the steps of: (1) providing a circumferential rotatable indexer; (2) sequentially transporting a plurality of metallic beverage containers from a first location to a second location along an indexed path using the rotatable indexer; (3) pausing transport of each of the plurality of metallic beverage containers at a dwell position for a predetermined time interval; (4) providing an image recorder at the dwell position; (5) providing rotational movement about a generally vertical axis extending through a center of the at least one of the plurality of metallic beverage containers by one of the image recorder or the metallic beverage container; (6) recording a plurality of images of a height from an open end to an opposing closed end of the at least one of the plurality of metallic beverage containers about a circumference of the at least one of the plurality of the metallic beverage containers during the providing rotational movement step; (7) creating a composite image from the plurality of images corresponding to the height and the circumference of the at least one of the plurality of metallic beverage containers; and (8) using a software routine to identify manufacturing defects on the composite image.

This aspect of the invention may include the following step: automatically culling a defective beverage container from a plurality of sequentially processed beverage containers. The invention may include an ejector positioned along the indexed path and activated by a software routine stored in the memory of the computer system. Activation of the ejector removes an individual beverage container from the inspection station when the second software routine identifies a manufacturing defect on the individual beverage container. The ejector may receive a fluid pressure from a source of fluid pressure in response to a signal originating from the computer system. The ejector may be a blow-off nozzle.

Another aspect of the present invention is directed to an apparatus for inspecting a metallic beverage container having a closed bottom opposite an open end, and a cylindrical sidewall extending upwardly from the bottom to a circumferential shoulder against a preset quality standard. The apparatus has an entry end and a first rotatable transfer wheel adjacent thereto. The first rotatable transfer wheel has a plurality of pockets, each adapted for receiving a beverage container therein. A rotatable indexer has a plurality of rotatable turntables about a circumference thereof. The rotatable indexer is rotatable about a central hub and each rotatable turntable is about a center axis associated with each rotatable turntable. A second rotatable transfer wheel is opposite the first transfer wheel and also has a plurality of pockets adapted for receiving beverage containers therein. An indexed path of the apparatus is defined by a portion of the plurality of pockets on the first rotatable transfer wheel, a portion of the plurality of rotatable turntables on the rotatable indexer, and a portion of the plurality of pockets on the second transfer wheel. A plurality of image recorders are aimed at the indexed path about the circumference of the rotatable indexer. A control means regulates or controls rotation of the first and second rotatable transfer wheels, the rotatable indexer, and the plurality of turntables. An ejector is located along the indexed path. A computer system comprises a memory which stores and executes a software comprising a first routine controlling the means for rotating, a second routine controlling the plurality of image recorders, a third routine comparing beverage container images against a preset quality standard, and a fourth routine for activating the ejector to remove a defective beverage container from a cue of beverage containers traversing the indexed path.

This aspect of the invention may include one or more of the following features, alone or in any reasonable combination. The ejector may receive a fluid pressure from a source of fluid pressure in response to a signal originating from the computer system. The ejector may be a blow-off nozzle. The apparatus may further comprise a software routine stored in the memory for stitching a plurality of images received from the cameras together to form a composite of a circumference of each metallic beverage container.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a side view of a metallic bottle;

FIG. 2 is a schematic representation of a prior art necking and flanging apparatus comprising a plurality of necking modules, at least one flanging module, and at least one reforming module;

FIG. 3 is a schematic representation of a necking and flanging apparatus of the present invention of the present invention comprising a plurality of necking modules, at least one flanging module, at least one reforming module, and an inspection module.

FIG. 4 is a perspective view of an inspection module used in conjunction with the present invention;

FIG. 5 is a top view of the inspection module of FIG. 4;

FIG. 6 is a perspective view of an inspection station showing an ejector in the form of a blow-off nozzle; and

FIG. 7 is a schematic view of a processing sequence featuring a necking and flanging apparatus sequentially aligned with a washing station and an inspection station of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

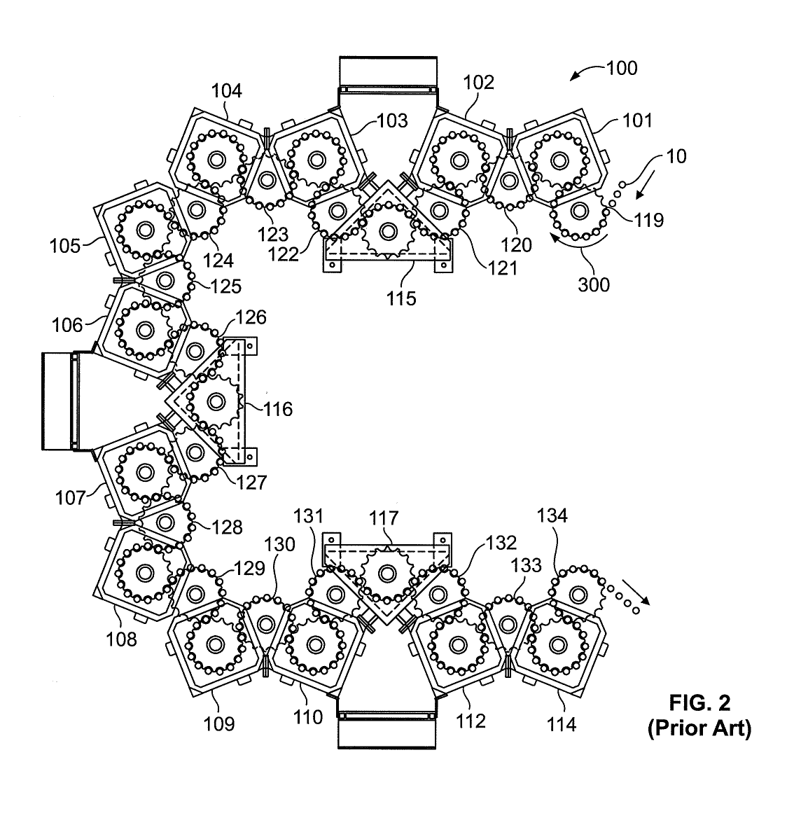

Referring to FIG. 2, a prior necking and flanging apparatus 100 for reducing a diameter of an open end of a metallic beverage container is illustrated. FIG. 2 depicts metal container bodies 10 being fed along an indexed path 300. This prior art apparatus has a plurality of necking stations. Ten such stations are shown, identified by numerals 101-110, respectively. A flanging station 112 and a reformer station 114 are also shown. Three drive stations 115-117 drive the necking and flanging apparatus 100. Sixteen transfer wheels 119-134 move the containers sequentially and in a serpentine indexed path 104 through the various necking, flanging and reformer stations. The transfer wheels 119-134, as well as the necking, flanging, and reformer stations have gears in mesh with each other to produce a synchronized continuous drive means for all of the components.

A variable-speed drive feature of the drive stations 115-117 allows automatic increase and decrease speeds to match the quantity of containers flowing through the apparatus to the flow in the remainder stations of the apparatus. The variable-speed drive also allows an operator to accurately index the components of the system relative to each other, including managing dwell times at each station during which a beverage container is processed, e.g. receiving a reduction in the open end diameter by treatment with a set of forming tools.

Each of the necking station modules 101-110 are substantially identical in construction so as to be interchangeable, and can be added to or subtracted from the system depending upon the type of container that is to be formed. Each of the necking station 101-110 has a plurality of circumferentially-spaced individual, substantially identical necking substations. The number of stations and substations can be increased or decreased to provide the desired necking operation for various sizes of cans. This process is well known on the art. See, for example, U.S. Pat. No. 5,497,900.

The arrangement of FIG. 2 shows cylindrical metal container bodies 10 which are made of conventional materials in any conventional manner, being fed sequentially by suitable conveyor means (not shown) into the necking and flanging apparatus 100. The conveyor means feeds the containers 10 to a first transfer wheel 119, as is known in the art. The containers 100 are then fed serially through the various stations by the remaining interconnecting transfer wheels 120-134.

More specifically, the first transfer wheel 119 delivers containers 10 to the first necking station 101, where a first necking operation is performed on the container. The containers 10 are then delivered to a second transfer wheel 120 which feeds the containers 10 to a second necking station 102 where a second necking operation is performed on the container 10. The container 10 is then removed from the second station 102 by a third transfer wheel 121 and fed to a third necking station 103 where a third necking operation is performed.

The containers are then sequentially moved through the fourth through tenth necking stations 104-110 to complete the necking operation. The necked containers 10 are next moved by transfer wheels 131,132 and drive station 118 to a flanging station 112 where a radially outwardly-directed flange 30 is produced on the container 10, as is well known in the art, and is delivered to a transfer wheel 133 for delivery to a reformer station 114 where a bottom portion of the container is reformed to impart additional strength to the container.

All of the moving members in the necking, flanging and reformer stations are driven by a drive stations 115-117, each of which includes a variable-speed motor connected to an output transmission. As will be discussed later, these motors can be controlled by a programmable controller housed, e.g., on a computer system to control the timing of the apparatus. Each of the transfer wheels 119-134, as well as the necking, flanging and reformer stations have gears in mesh with each other to produce a synchronized continuous drive means for all of the components.

The variable-speed drive feature of drive stations 115-118 allow automatic increase and decrease of speed to match the quantity of containers flowing through the apparatus 100 to the flow in the remainder of the container line. The variable-speed drive also allows the operator to accurately index the components of the system relative to each other.

The present invention is primarily aimed at detecting manufacturing defects exhibited by an aluminum bottle after labeling and subsequent to necking, flanging and reforming as described above. Accordingly, the inventors contemplate that an inspection station as will be described below can be incorporated into the manufacturing process as an additional station or separate machine in a necking and flanging apparatus as described above. The description set forth below is consistent with that design. However, the inventors further contemplate that the inspection station 150 described below can be incorporated into almost any desired step of the aluminum bottle making process prior to palletizing the containers due the handling and transport mechanisms associated with the invention and the great flexibility of the inspection speed and aluminum bottle transport associated therewith. In such a manufacturing process, beverage containers are typically transferred from station to station by transfer wheels, conveyors, or some combination of the two and incorporation of the inspection station 150 can be achieved by sequentially aligning the inspection station at any point in the process.

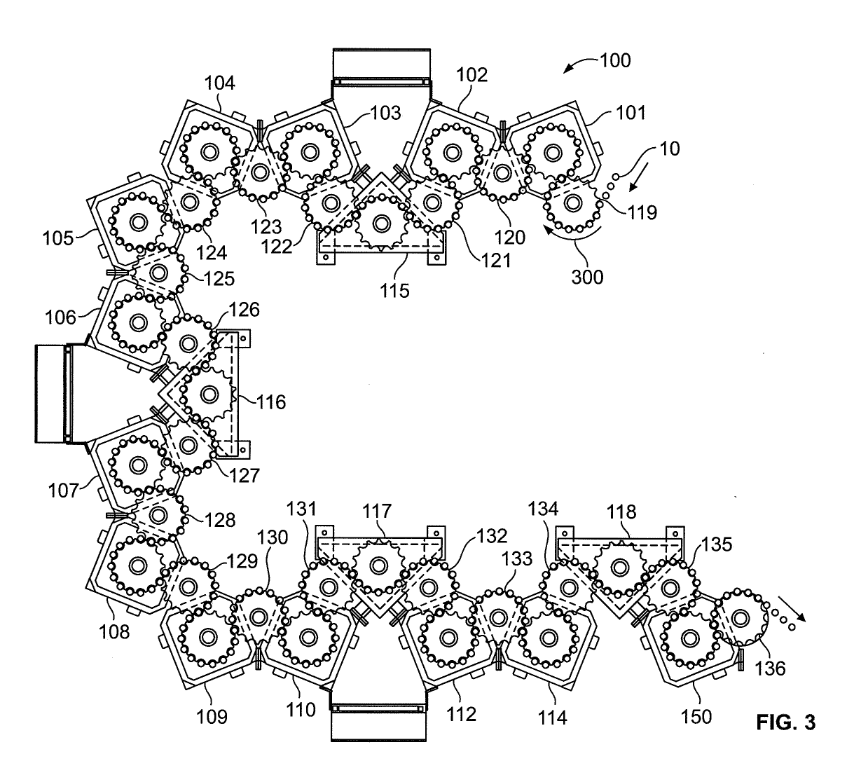

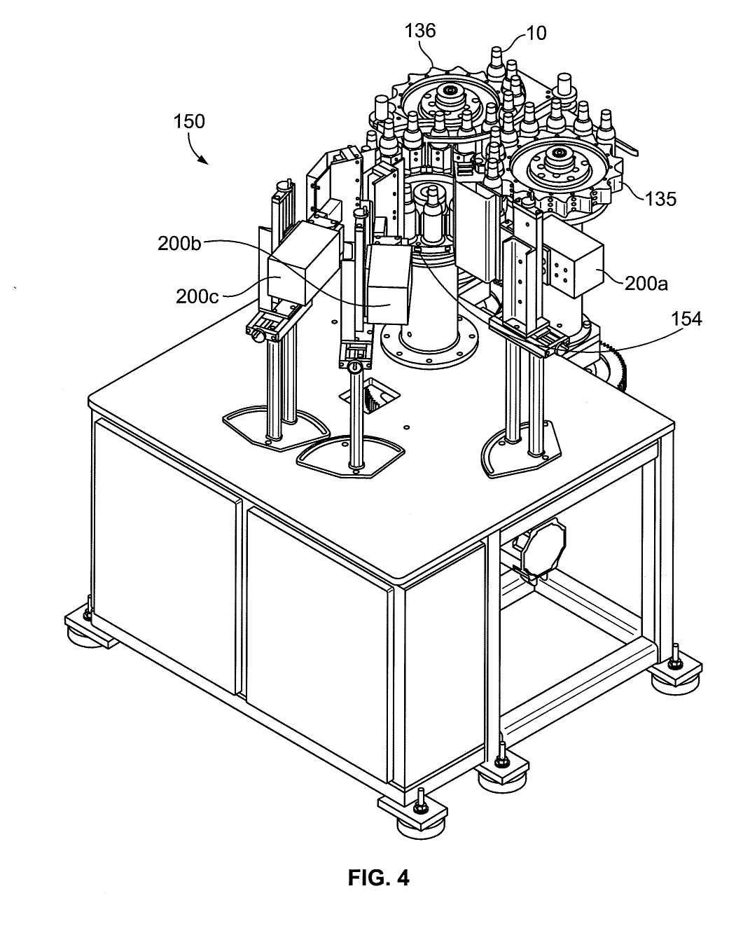

Now referring to FIGS. 3-5, principles of the present invention are illustrated. The present invention comprises a necking and flanging apparatus 100 having and additional in-line inspection station 150 which receives containers 10 sequentially in the manner described above. Accordingly, the schematic apparatus of FIG. 2 is identical to the schematic representation of FIG. 3, with the following exception. In FIG. 3, the apparatus 100 has an additional drive station 118 in operational communication with transfer wheel 134, two additional transfer wheels 135,136, and an additional inspection station 150 for automated inspection of the beverage container following the reformer station 114.

The inspection station 150 includes image technology to capture and record desired images of the beverage container with one or more image recorders, preferably digital cameras 200a,b,c. Line scan technology may be employed to take a beverage container image. A snap shot photograph of the beverage container is taken as the beverage container 10 or the camera 200a,b,c is rotated to capture images of an entire circumference of the beverage container 10. Preferably, the metallic beverage container 10 is rotated about a center vertical axis at one or more dwell positions during a predetermined time interval wherein indexing of the beverage containers 10 is paused to allow the photographs to be taken as the beverage container is rotated about a central vertical axis. Approximately 1024 photographs of the beverage container 10 are taken as it is rotating. Beverage containers 10 preferably maintain 1¼ revolutions for taking the preferable number of a plurality of individual photographs. The photographs are stitched together using a software routine to produce a composite image of the beverage container. The photographs are collected by a computer system 204, which may comprise one or more computers and/or controllers in communication with one another, in communication with the cameras 200a,b,c. The software routine is stored in a memory on the computer system 204. Upon execution of the software routine, the composite image is created and outputted by the software. A further software may perform a pass/fail analysis on the composite image or any individual photograph or photographs to determine the surface quality of the beverage container 10, primarily the existence or absence of surface defects such as dents, wrinkles, splits, scale, blemishes, and the like.

The individual photographs may capture an image of a section of the circumference of the entire height of the beverage container 10, from the open end to the enclosed bottom portion. Alternatively, the individual photographs may capture an image of a section of a circumference of the beverage container 10 and only a portion of the height of the container. However, in either case, the composite image includes images of at least a portion of the entire height and the entire circumference of the beverage container 10 stitched together to form the composite image. Stated another way, a plurality of images of at least a portion of the height of the beverage container 10 from the open end to the enclosed end and about the entire circumference of the container are recorded and processed to arrive at the composite image.

In another embodiment, the individual photographs are taken of the open end from the flange 30 to the uppermost point of the sidewall 18 to capture images of the areas of the container most prone to forming defects, i.e. splits, wrinkles, scratches, fractures and the like. It should be noted that known automated prior art inspection techniques viewed containers from above downwardly. Therefore, a blind spot would occur in the shoulder region where the container undergoes its greatest amount of diametric reduction going from the sidewall 18 to the reduced diameter neck 28. A camera angle from above could not focus on this area. The present invention eliminates the blind spot of the known prior art.

The inspection station 150 includes an indexer 154 for accepting the beverage containers 10 from a first transfer wheel 135 and sequentially transferring the beverage containers 10 along an indexed path comprising a plurality of dwell positions to a second transfer wheel 136 and delivery from the inspection station 150 to an exit conveyor (no shown) of the apparatus 100.

The indexer 154 of the present invention is circumferential and rotates about a central axis. It has a plurality of pockets 158 adapted, as in sized and shaped, to support, control, and properly the sidewall of the beverage container 10 therein and to prevent misalignment of the beverage container through the inspection process. Each pocket has a turntable associated therewith, preferably a rotatable vacuum chuck 164 which utilizes a vacuum pressure to maintain the beverage containers 10 in position as the indexer 154 indexes or transports the beverage containers 10 through an inspection process as described above. Thus, the vacuum chucks 164 are each in fluid communication with a source of fluid pressure. The vacuum pressure is used to attach each beverage container 10 to the turntables. The vacuum chucks 164 are rotatable about an upright axis that is at least a substantially vertical axis, preferably a vertical axis. The rotation of the vacuum chuck imparts a similar rotation to an upright or substantially vertical beverage container 10. The vacuum chucks 164 further include a chuck nose that fits within a bottom domed portion of the beverage container 10 to further support the beverage container 10 through the inspection process.

The vacuum chucks 164 are substantially free-wheeling. This enables a spinner belt 168 wound around a plurality of idler pulleys 172 to impart rotational movement to the beverage containers 10 attached to the vacuum chucks 164. One of the idler pulleys 172 is operably joined to a spinner motor which in turn drives the spinner belt 168. The spinner motor may be an ac motor.

The spinner belt 168 is preferably a 5 mm pitch timing belt and the pulleys 172 are 5 mm pitch. This driving belt represents a new way to use a timing belt. Usually a timing belt is used to make sure that pulleys move at the same time and at the same rate. The inventors use it to actually drive the vacuum chucks 164, and they are all being tracked by a common encoder.

The encoder tracks rotational movement of the indexer turret and communicates the information to the computer for positional control. It communicates by taking the angular velocity of the pulley shaft and converting the information to digital data for use by the computer. There are actually two encoders, one for the indexer turret and one of the turntable information.

As shown, 8 vacuum chucks 164 are driven by the belt 168, achieving an identical angular rotation. One advantage of this timing belt system allows the beverage containers 10 to be stationary (i.e. not spinning) at infeed and discharge. Because they are not spinning, a vacuum can be used to pick up the beverage container 10. The angular rotation remains constant between the 8 vacuum chucks 164. This also reduces potential beverage container 10 damage.

The inspection station 150 runs at 300 cans per minute or more. This is based on the combined move time and dwell time required by the process. As the move time and the dwell time are reduced, throughput is increased. In the future, the inventors contemplate that this invention will be capable of inspecting 400 to 600 containers per minute. If more limited inspection is performed, the number of inspections may exceed 1000 to 2000 containers per minute. A servo motor is used to control dwell and index time. Thus, the speed of the index and output of the software can be increased with decreased image or photograph acquisition time without swapping out parts of the apparatus.

Most available camera inspection systems are fixed speed. One advantage of the present apparatus is that a user can adjust the dwell time for the cameras 200a,b,c due to servo control. It follows that a user may also slow the rate or dwell down if more time is needed. Thus, a user may increase and decrease the rate as necessary or desires. Therefore, as camera technology improves and images can be obtained in less dwell time, the present inspection station 150 can automatically get faster. For example, as the inspection station index rate is increased, the rate at which the beverage containers 10 rotate must also be increased to ensure that we get more than 360 degrees of photos taken around the beverage container 10. The adjustability of the dwell and index rate is one of the advantages of the servo technology.

A programmable controller which may be included with the computer system 204 is in communication with the inspection station 150 and the one or more servo motors which drive the indexer 154 and the transfer wheels 135,136 on the inspection station 150. It can be used to program the indexer 154 to any predetermined dwell time independent of the speed of the necking and flanging apparatus 100 or conjunction therewith to ensure a continuous processing of beverage containers 10 through the apparatus 100 without any one station moving slower than another. In other words, the inspection station 150 is not a bottleneck operationally to the apparatus 100. Thus, inspection station 150 can be programmed based on time without mechanical intervention. This is very important as other technology improves.

It should be understood that the inspection station 150 is programmable, and any number of dwell time preferences can be achieved on the same station 150 without the need for mechanical changes to the station 150.

Furthermore, the controller is capable of synchronizing the movement of the indexer 154 with the overall apparatus 100. It generally follows that the programmable controller which may be housed on the computer system 204 can be used to control the timing of not only the inspection station 150 but also the entire apparatus to ensure a smooth flow and processing of beverage containers 10 without unnecessarily long dwell times wherein containers 10 rest without being formed, reformed, flanged, or inspected. In other words, addition of the inspection station 150 into the apparatus 100 does not cause the apparatus 100 to require additional mechanical timing cams or other means, as timing can be controlled by the servos and one or more programmable controllers, such as one included on computer system 204.

In one embodiment, a processing time is 200 msec times 15 pockets per turret (i.e. 15 chucks 164), having a 24 degree index, yields inspection of 300 containers per minute. The beverage containers 10 are transported to the transfer wheel 135 and indexed to a transfer point to a vacuum chuck 164 on the indexer 154. Each beverage container 10 rotates on the vacuum chuck 164 for at least a full 360 degree inspection.

The present invention uses line scan technology. It will take 1024 pictures per beverage container 10. This allows the apparatus to take a strip of the beverage container 10 can at high resolution and build a composite image of 360 degree of the beverage container 10 one strip at a time. This allows the current apparatus to detect smaller defects.

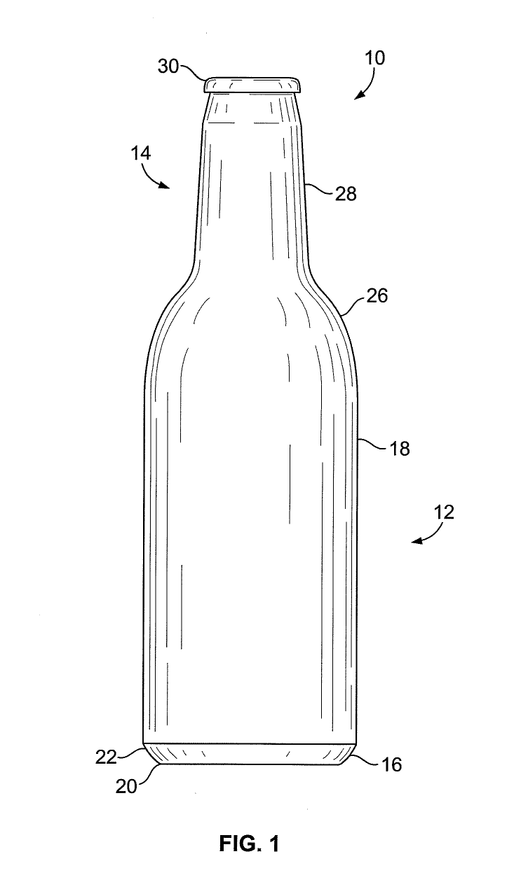

For typical beverage cans, only a small uppermost portion of the can is necked radially inwardly. So for cans, the static technology only has to look at a small portion of the can, so it works well enough. However, for beverage containers 10 like those show in FIG. 1, there is a much longer neck, so there is more area of the beverage container 10 that must has be inspected. The present inspection station 150 allows increased inspection without adversely affecting the overall speed or output of the necking and flanging apparatus 10. This is a very desirable advantage achieved by the apparatus of the present invention.

Furthermore, with a typical straight wall beverage can, an inspection device need only look downwardly to image the entire sidewall of the beverage can and defects can be seen from the inside looking radially outwardly. But with a beverage container 10 of FIG. 1, inspection cannot be performed by looking inside to outside because the neck hole is very small and an inspection device (camera) cannot see down the internal walls of the shoulder 26 and sidewall 18. As described above, the long-necked aluminum bottles have a blind spot created by the long neck 28 and the shoulder 26. The present inspection station 150 eliminates the blind spot.

Current inspection is often performed by hand at a rate of about 10 beverage containers per minute. An inspector currently pulls a beverage container 10 from the production line and manually inspects it for 360 degrees and places it back on the manufacturing line if it passes. Obviously, it is cost prohibitive to inspect every container. However, 100% of the containers 10 receive manual inspection. The present invention will perform 100% inspection at a rate of 1 to 240 cans per minute, which keeps up with the current rate of manufacturing metallic beverage containers 10 that resemble bottles as shown in FIG. 1. Therefore, the inspection station of the present invention relieves a manufacturing bottleneck and/or lowers the cost of production.

It should be noted that more or fewer camera 200a,b,c can be utilized if needed. The inventors contemplate as many as 7 cameras for rotating containers and 2 for stationary containers, for a total of 9 cameras. Using additional cameras can help increase the speed of the inspection even greater. Or, different areas of the container can be inspected without losing or sacrificing speed of the overall apparatus 10.

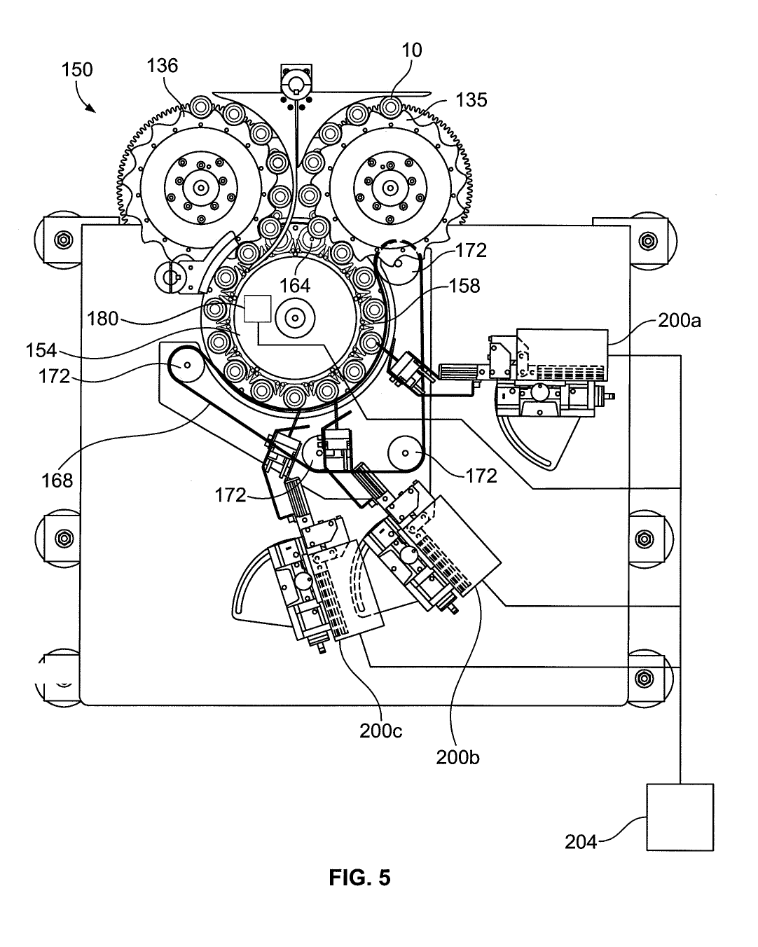

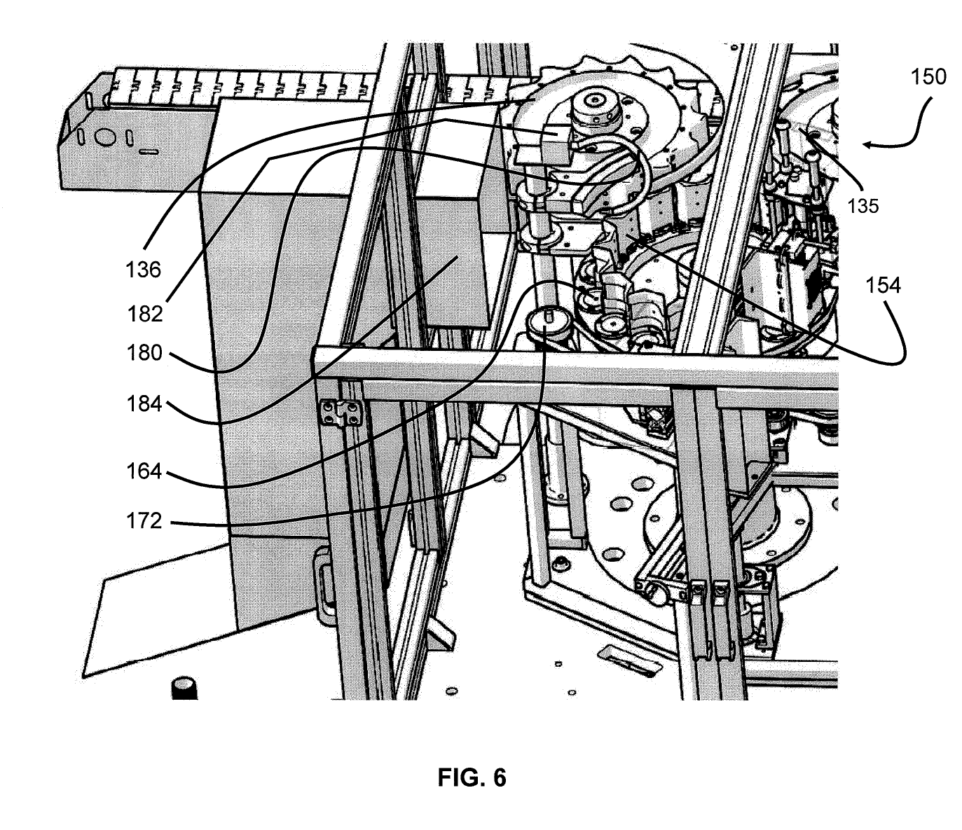

As shown in FIGS. 5 and 6, the inspection station may be outfitted with a rejection system. The can rejection system includes an ejector positioned along the indexed path associated with the indexer 154 for culling an individual beverage container 10 having a detected defect from the manufacturing stream of sequentially processed beverage containers prior to palletizing the defective container. The ejector may be a mechanical spring-loaded kick-out, a mechanical arm, pendulum, plunger, piston, plate, or grasping apparatus, or other mechanical system, but is preferably a blow-off nozzle 180 includes a source of fluid pressure 182 in which activation of same is either manually controlled or, more preferably controlled by a signal originating from a software routine stored in the memory on the computer 200 which compares the results of the camera inspection to a quality standard preset by the manufacturer. If, upon comparison of the inspected beverage container to the quality standard, the beverage container 10 is deemed to fail the quality standard, the fluid pressure is activated and delivered through the blow-off nozzle 180 to the beverage container 10 which thrusts the beverage container from the indexer 154 to a reject chute 184 and into a waste area, such as waste bin.

The ejector is located along the indexed path of the inspection station 150. That is, the ejector is capable of removing a defective beverage container from the cue of beverage containers on the inspection station 150. Accordingly, the ejector is located along the circumference of the indexer 154 after the cameras 200a,b,c but before the second transfer wheel 136.

In terms of processing, a cue of a plurality of beverage containers enters the inspection station at an entry end via the first transfer wheel 135. Each beverage container in the cue is transferred from the first transfer wheel 135 to the indexer 154. Each beverage container is inspected by the cameras 200a,b,c in conjunction with a software routine on the computer system 204. If a beverage container does not meet a quality standard stored on the computer system, the computer system sends a signal to the ejector or source of power at an appropriate time when the defective beverage container is at or near the ejector wherein the ejector removes the defective beverage container from the cue prior to exiting the inspection station 150 at an exit end via the second transfer wheel 136.

In one embodiment, an inspection station 150 is for inspecting a metallic beverage container having a closed bottom opposite an open end, and a cylindrical sidewall extending upwardly from the bottom to a circumferential shoulder against a preset quality standard. The inspection station 150 has an entry end and a first rotatable transfer wheel 135 adjacent thereto. The first rotatable transfer wheel 135 has a plurality of pockets, each adapted for receiving a beverage container 10 therein. A rotatable indexer 154 has a plurality of rotatable turntables 164 about a circumference thereof. The rotatable indexer 154 is rotatable about a central hub and each vacuum chuck 164 is rotatable about a center axis associated with each rotatable vacuum chuck 164. A second rotatable transfer wheel 136 is opposite the first transfer wheel 135 and also has a plurality of pockets adapted for receiving beverage containers 10 therein. An indexed path of the inspection station 150 is defined by a portion of the plurality of pockets on the first rotatable transfer wheel 135, a portion of the plurality of rotatable turntables on the rotatable indexer 154, and a portion of the plurality of pockets on the second transfer wheel 136. A plurality of cameras 200a,b,c are aimed at the indexed path about the circumference of the rotatable indexer 154. One or more motors, preferably servo motors control rotation of the first and second rotatable transfer wheels 135,136, the rotatable indexer 154, and the plurality of turntables. An ejector is located along the indexed path. A computer system comprises a memory which stores and executes a software comprising a first routine controlling the means for rotating, a second routine controlling the plurality of cameras, a third routine comparing beverage container images against a preset quality standard, and a fourth routine for activating the ejector to remove a defective beverage container from a cue of beverage containers traversing the indexed path.

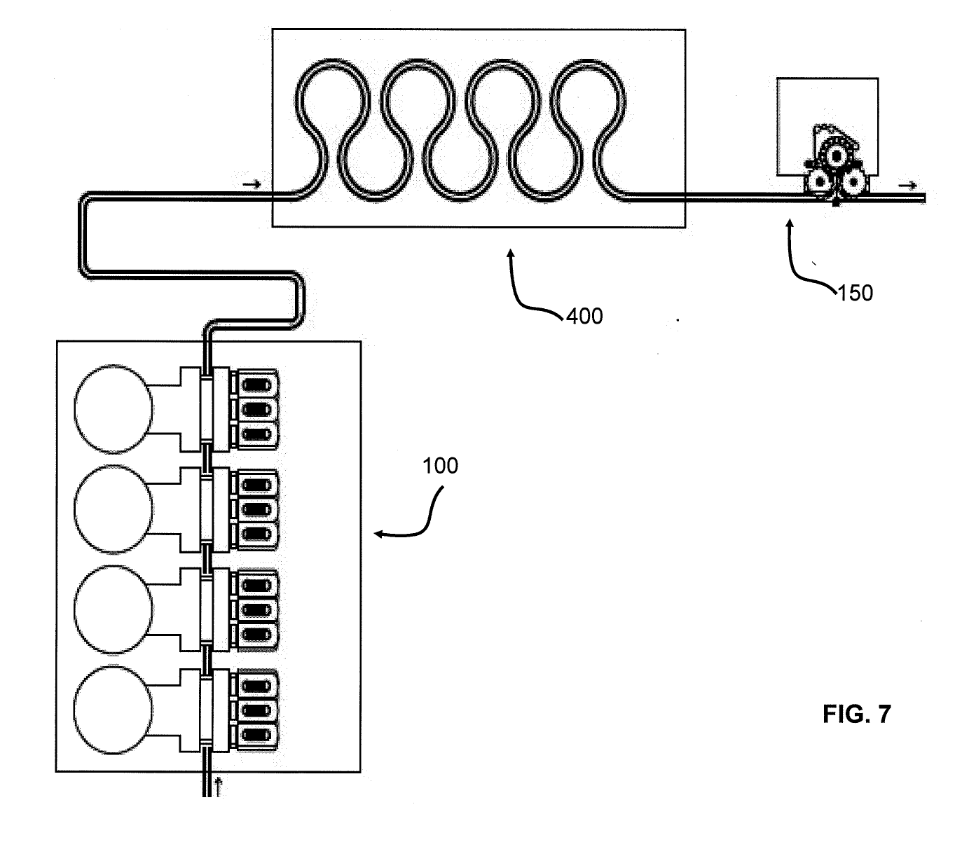

A shown in FIG. 7 and as set forth above, the inspection station 150 can be placed in any physical location prior to palletizing the containers. In FIG. 7, the inspection station 150 is shown sequentially aligned with the necking and flanging apparatus 100 and a washing station 400 which rinses and dries the containers 10 subsequent to forming. Containers 10 are processed in the direction of the arrows and inspected subsequent to necking and washing but prior to palletizing.

The inspection of the beverage container 10 in a vertical orientation is important. Due to the weight distribution of the beverage containers 10 described herein, they cannot be transported well horizontally. In other words, one end of the container is much heavier than the other. The heavy end will drop first. It would be very difficult to transport and inspect the beverage container 10 while it was in the horizontal position because of the uneven weight distribution.

As used herein, the terms “first,” “second,” “third,” etc. are for illustrative purposes only and are not intended to limit the embodiments in any way. Additionally, the term “plurality” as used herein is intended to indicate any number greater than one, either disjunctively or conjunctively as necessary, up to an infinite number. The terms “joined,” ‘attached,” and/or “connected” as used herein are intended to put or bring two elements together so as to form a unit, and any number of elements, devices, fasteners, etc. may be provided between the joined, attached or connected elements unless otherwise specified by the use of the term “directly” and/or supported by the drawings. The phrase “sequentially aligned” is intended to indicate a manufacturing arrangement wherein items of manufacture can be transferred sequentially between manufacturing stations, and any number of manufacturing stations can be sequentially aligned without regard to the order of the manufacturing steps or processes carried out at each manufacturing station.

While the specific embodiments have been illustrated and described, numerous modifications come to mind without significantly departing from the spirit of the invention, and the scope of protection is only limited by the scope of the accompanying Claims.

What is claimed is:

1. An apparatus for continuously reforming an open end of a metallic can body comprising:
a plurality of sequentially aligned necking stations, each necking station reducing a diameter of an open end of a metallic beverage container body wherein a subsequent necking station reduces the diameter of the open end of the metallic beverage container an amount beyond a reduction in the diameter taken at a previous necking station;
a flanging station sequentially aligned with a last of the plurality necking stations wherein the open end of the metallic beverage container is further reformed by the flanging station;
an inspection station sequentially aligned with the flanging station comprising an image recorder for capturing a plurality of images about a circumference of the metallic beverage container as the metallic beverage container completes one full rotation about a generally vertical axis during a dwell period; and
a plurality of transfer wheels sequentially aligned with the plurality of necking stations, the flanging station, and the inspection station, the transfer wheels sequentially transferring the metallic container between each of the plurality of necking stations, the flanging station, and the inspection station.

2. The apparatus of claim 1 further comprising:
a computer system having a memory, the computer system in communication with the image recorder and receiving images of the beverage container from the image recorder.

3. The apparatus of claim 2 further comprising:
a first software routine stored in the memory for stitching the plurality of images together to form a composite of a circumference of each metallic beverage container.

4. The apparatus of claim 3 further comprising:
a second software routine stored in the memory for identifying manufacturing defects on the composite.

5. The apparatus of claim 3 wherein the inspection station comprises an ejector activated by a third software routine stored in the memory of the computer system wherein activation of the ejector removes an individual beverage container from the inspection station when the second software routine identifies a manufacturing defect on the individual beverage container.

6. The apparatus of claim 5 wherein the ejector receives a fluid pressure from a source of fluid pressure in response to a signal originating from the computer system.

7. The apparatus of claim 6 wherein the ejector is a blow-off nozzle.

8. The apparatus of claim 1 further comprising:
a washing station sequentially aligned with the plurality of necking stations, the flanging station, and the inspection station.

9. The apparatus of claim 8 further comprising:
a means for transferring the beverage containers from the plurality of necking stations to the flanging station, from the flanging station to the washing station, and from the washing station to the inspection station.

10. The apparatus of claim 8 further comprising:
a beverage container processing sequence comprising transfer of the beverage containers from the plurality of necking stations to the flanging station, transfer of the beverage containers from the flanging station to the washing station and from the washing station to the inspection station.

11. An apparatus for inspecting a metallic beverage container having a closed bottom opposite an open end, a cylindrical sidewall extending upwardly from the bottom to a circumferential shoulder, and a neck of reducing diameter extending upwardly from the shoulder, the apparatus comprising:
a circumferential first indexer for sequentially transporting a plurality of metallic beverage containers from a first location to a second location along an indexed path having a plurality of dwell positions wherein each of the plurality of metallic containers pauses at the dwell positions for a predetermined time interval as each of the plurality of metallic beverage containers is sequenced from the first location to the second location, the first indexer comprising a plurality of turntables, each turntable supporting an enclosed bottom portion of the metallic beverage container and rotational about a generally vertical axis for transferring rotation to the metallic beverage container, each turntable further transferred by the first indexer along the indexed path from the first location to the second location; and
an image recorder aimed at one of the dwell positions for capturing a plurality of images about a circumference of each of the plurality of metallic a beverage containers as each of the plurality of metallic beverage containers completes at least one full rotation about the generally vertical axis during the predetermined time interval.

12. The apparatus of claim 11 further comprising:
a computer system having a memory, the computer system in communication with the image recorder and receiving images of the beverage container from the image recorder.

13. The apparatus of claim 12 further comprising:
a first software routine for stitching the plurality of images together to form a composite of a full circumference of each metallic beverage container.

14. The apparatus of claim 13 further comprising:
a second software routine for identifying manufacturing defects on the composite.

15. The apparatus of claim 14 further comprising:
another image recorder aimed at a second dwell position of the plurality of dwell positions for capturing a plurality of images about a circumference of each of the plurality of metallic beverage containers as each of the plurality of metallic beverage containers completes at least one full rotation about the generally vertical axis during the predetermined time interval.

16. The apparatus of claim 14 further comprising:
an ejector positioned along the indexed path and activated by a third software routine stored in the memory of the computer system wherein activation of the ejector removes an individual beverage container from the inspection station when the second software routine identifies a manufacturing defect on the individual beverage container.

17. The apparatus of claim 16 wherein the ejector receives a fluid pressure from a source of fluid pressure in response to a signal originating from the computer system.

18. The apparatus of claim 17 wherein the ejector is a blow-off nozzle.

19. An apparatus for inspecting a metallic beverage container having a closed bottom opposite an open end, and a cylindrical sidewall extending upwardly from the bottom to a circumferential shoulder, the apparatus comprising:
a first indexer for sequentially transporting a plurality of metallic beverage containers from a first location to a second location along an indexed path having a plurality of dwell positions wherein each of the plurality of metallic containers pauses at the dwell positions for a predetermined time interval as each of the plurality of metallic beverage containers is sequenced from the first location to the second location, the first indexer comprising a plurality of turntables, each turntable supporting an enclosed bottom portion of the metallic beverage container and rotational about a generally vertical axis for transferring rotation to the metallic beverage container, each turntable further transferred by the first indexer along the indexed path from the first location to the second location;
an image recorder aimed at one of the dwell positions for capturing a plurality of images about a circumference of each of the plurality of metallic a beverage containers as each of the plurality of metallic beverage containers completes at least one full rotation about the generally vertical axis on one of the plurality of turntables during the predetermined time interval;
a computer system in communication with the image recorder and comprising a software routine for stitching together the plurality of images to form a composite image representing the circumference of each of the metallic beverage containers and a software for identifying defects on the metallic beverage container; and
an ejector positioned along the indexed path and activated by signal originating from the computer system wherein activation of the ejector removes the metallic beverage container from the inspection station when a manufacturing defect is identified on the metallic beverage container beverage container.

20. An apparatus for inspecting a metallic beverage container having a closed bottom opposite an open end, and a cylindrical sidewall extending upwardly from the bottom to a circumferential shoulder, the apparatus comprising:
an entry end;
a first rotatable transfer wheel having a plurality of pockets, each adapted for receiving a beverage container therein;
a rotatable indexer having a plurality of rotatable turntables about a circumference thereof, the rotatable indexer being rotatable about a central hub and each rotatable turntable rotatable about a center axis;
a second rotatable transfer wheel opposite the first transfer wheel also having a plurality of pockets, each adapted for receiving a beverage container therein;
an indexed path defined by a portion of the plurality of pockets on the first rotatable transfer wheel, a portion of the plurality of rotatable turntables on the rotatable indexer, and a portion of the plurality of pockets on the second transfer wheel;
a plurality of image recorders aimed at the indexed path about the circumference of the rotatable indexer;
means for rotating the first and second rotatable transfer wheels, the rotatable indexer, and the plurality of turntables;
an ejector located along the indexed path; and
a computer system comprising a memory storing a software comprising a first routine controlling the means for rotating, a second routine controlling the plurality of image recorders, a third routine comparing beverage container images against a preset quality standard, and a fourth routine for activating the ejector to remove a defective beverage container from a cue of beverage containers traversing the indexed path.

21. A method of inspecting a metallic beverage container having a closed bottom opposite an open end, a cylindrical sidewall extending upwardly from the bottom to a circumferential shoulder, and a neck of reducing diameter extending upwardly from the shoulder, the method comprising the steps of:
sequentially transporting a plurality of metallic beverage containers from a first location to a second location along an indexed path having a plurality of dwell positions therebetween;
pausing transport of each of the plurality of metallic beverage containers at one of the dwell positions for a predetermined time interval;
recording a plurality of images of a portion of a height from an open end to an opposing closed end of each of the plurality of metallic beverage containers about a circumference of each of the plurality of the metallic beverage containers; and
creating a composite image corresponding to the height and the circumference of each of the plurality of metallic beverage containers from the plurality of images.

22. The apparatus of claim 21 further comprising:
using a software routine to identify manufacturing defects on the composite image.

23. The apparatus of claim 21 further comprising:
rotating each of the plurality of metallic beverage containers about a generally vertical axis defined by a center of each of the plurality of metallic beverage containers during the recording step.

24. A method of inspecting a metallic beverage container having a closed bottom opposite an open end, a cylindrical sidewall extending upwardly from the bottom to a circumferential shoulder, and a neck of reducing diameter extending upwardly from the shoulder, the method comprising the steps of:
providing a circumferential first indexer;
sequentially transporting a plurality of metallic beverage containers from a first location to a second location along an indexed path using the first indexer;
pausing transport of each of the plurality of metallic beverage containers at a dwell position for a predetermined time interval;
providing an image recorder at the dwell position;
providing rotational movement about a generally vertical axis extending through a center of the at least one of the plurality of metallic beverage containers by one of the image recorder or the metallic beverage container;
recording a plurality of images of a portion of a height from an open end to an opposing closed end of the at least one of the plurality of metallic beverage containers about a full circumference of the at least one of the plurality of the metallic beverage containers during the providing rotational movement step;
creating a composite image from the plurality of images corresponding to the height and the circumference of the at least one of the plurality of metallic beverage containers; and
using a software routine to identify manufacturing defects on the composite image.
